(19) United States
(12) Patent Application Publication
(10) Pub. No.: US 2019/0000261 A1
(43) Pub. Date: Jan. 3, 2019

(54) METHOD AND APPARATUS FOR PRODUCING STEEPED COFFEE USING CYCLONIC AGITATION

(71) Applicant: COFFEEWORKS, INC., Coeur D'Alene, ID (US)

(72) Inventors: Jonathon D. McClafferty, Post Falls, ID (US); Brandon Jeffries LaBreck, Coeur d'Alene, ID (US)

(21) Appl. No.: 15/641,178

(22) Filed: Jul. 3, 2017

(51) Int. Cl. A47J 31/44; A47J 31/06; A47J 31/46

(52) U.S. Cl. CPC A47J 31/4403; A47J 31/46; A47J 31/06

(57) ABSTRACT

A beverage steeping apparatus comprising a tank and agitation system, wherein the agitation system is configured to maintain particulates inside the tank in a state of suspension, such that the particulates are completely immersed in liquid inside the tank and that the particulates are unable to settle or congregate in any one specific location within the tank.

### CROSS-REFERENCE PARAGRAPH

This application claims the benefit of U.S. Provisional Application No. 62/357,543 filed on Jul. 1, 2016, entitled “ENCLOSED FULL PROCESS COLD STEEPED COFFEE PRODUCTION APPARATUS”, the contents of which are incorporated herein by reference as though set forth in their entirety. This application claims the benefit of U.S. Provisional Application No. 62/473,120 filed on Mar. 24, 2017, entitled “METHOD AND VESSEL FOR PRODUCING COLD BREWED COFFEE”, the contents of which are incorporated herein by reference as though set forth in their entirety. This application claims the benefit of U.S. Provisional Application No. 62/482,045 filed on Apr. 17, 2017, entitled “METHOD AND VESSEL FOR PRODUCING STEEPED COFFEE USING CYCLONIC AGITATION”, the contents of which are incorporated herein by reference as though set forth in their entirety.

### FIELD OF INVENTION

This invention generally relates to beverage production and manufacture, particularly to the manufacture of cold-steeped coffee, also referred to as cold brewed coffee. It is to be understood that the invention may be applied to any beverage whereby 1) the primary ingredient is steeped in water or liquid for an optimal amount the time to extract compounds 2) wherein it is desirous to filter most larger particulates from the compounds while ensuring that the most flavor is extracted in a short amount of time, and that 3) clean-up can happen in an expedited fashion.

### BACKGROUND OF THE INVENTION

Cold-steeped coffee manufacturing has often used relatively large containers, usually buckets, having a five to fifty-gallon capacity. Commercially available units, specifically for cold-steeping of coffee, may be found in the fifteen to thirty-gallon range and larger. These consist of a stainless steel vessel, and may optionally include a spigot or lid. The stainless steel vessel may also include a mesh filter basket or flat filter bottom. During the steeping process, the contents of the vessel are stirred with a paddle, large spoon, or an industrial impeller-type mixer. In most cases these mixing implements are not stored in a food-safe environment or cleaned between uses. This practice increases the likelihood of pollutants by creating multiple opportunities for contamination, as well as material cast off from the mixing implements and equipment used therewith. They are generally stored at room temperature within an environment much more like a shop than a kitchen. As such, they are often subject to vermin, pollutants, and bacterial contamination. Further, circulating the contents in this way causes inconsistent brewing and steeping, leaving grounds or the steeping particulates to rest in “dead areas” on the floor of the vessel and adjacent to the filter. This increases steeping time, and makes the quality of the end product highly dependent on labor quality and the diligence of the individual or individuals in charge of mixing. While this is somewhat alleviated by systems that employ a fixed, in-tank, impeller or mixing mechanism, these mechanisms introduce unreliable variables to the system as well. The blades of the impeller will further degrade optimally sized grounds or particulate, causing more solids to pass through the filtration system and either become part of the final product, or be removed by expensive secondary and tertiary filtration systems. The invention described here is different from existing practices. Because of the requirements of the quantities to be manufactured, the apparatus is distinctly different from other coffee machines in regards to circulation within the steeping vessel, controlled agitation of grounds during steeping, and filtration internal to the vessel.

The apparatus described herein has an advantage in that it requires fewer moving parts, reduces chances of contamination, ensures higher levels of extraction while reducing time required to extract a finished product.

Consistency in production is important to the quality of the final product. With coffee, it is important that the particulate size be consistent in nature, and remain so throughout the steeping process. Approximately 30% of the matter in roasted coffee particles can be dissolved in water. However, the optimum extraction of the coffee particle's soluble solid is 18-22% as not all flavor compounds are pleasant and undesirable flavors dissolve slowest. Thus, employing any process that further increases the variability in the size of the particulates leads to uneven steeping, and a lower quality product. Grounds or particulate allowed to rest can also decrease the quality of extraction. Grounds or particulate resting on the bottom of the vessel yield less product than grounds and particulate in constant contact with the fluid in which they are being steeped. The apparatus and method described herein minimizes the damage to the consistency of the grounds, enhancing the quality and flavor of the final product. Control over the steeping is increasingly important since different varieties of coffee and different roasts of these varieties have different wet viscosities and different timetables for optimal extraction of solids, i.e., different recipes. The invention address this too, by ensuring that the grounds or particulate remain suspended as they steep, increasing the reliability of the recipes. Similar issues exist with elements other than coffee.

Accordingly, what is needed is a cold steeping apparatus that allows for proper agitation and specific control over the entire steeping process.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to an apparatus configured to provide constant and complete agitation of substrate suspended in a liquid medium, wherein the liquid medium may be water and the substrate may be coffee grounds.

One embodiment of a beverage steeping apparatus may comprise a tank; a filter system, wherein the filter system comprises a mesh filter; one or more inlet ports; an outlet port, wherein the outlet port is configured to receive and be covered by the mesh filter, wherein the mesh filter is configured to releasably engage the outlet port; and a pump; wherein the pump is configured to pump a liquid into the tank through the one or more inlet ports and out through the outlet port; and an agitation system configured to maintain particulate matter in a state of suspension in the liquid in the tank. The agitation system may comprise one or more agitators. In one embodiment, the one or more agitators may be motor-driven rotable shafts with one or more fins at a distal end of the one or more agitators, wherein the one or more agitators are mounted at an angle of between 30° and 60° from a vertical plane relative to the tank; and wherein a rotation speed of the one or more agitators is adjustable. Alternatively, the agitation system may comprise one or more inlet ports configured to introduce the liquid into the vessel at a horizontal angle and vertical angle conducive to agitating particulate matter contained within the vessel. The pump may be configured to pump liquid through the one or more inlet ports at a rate of about 2-10 gallons per minute and into the tank. The horizontal angle may be between −85° and 85°. The one or more inlet ports may comprise lower inlet ports; wherein the vertical angle is between 5° and 85°. The one or more inlet ports comprise upper inlet ports; wherein the vertical angle is between −5° and −85°. The beverage steeping apparatus may further comprise one or more recirculation valves; wherein the one or more recirculation valves comprise an open configuration and a closed configuration; wherein when the one or more recirculation valves are in an open configuration, the liquid passing through the outlet port is routed through the recirculation valves and into the one or more inlet ports; wherein when the one or more recirculation valves are in a closed configuration, the liquid that exits the tank through the outlet port and is not routed through the one or more recirculation valves to the one or more inlet ports. The beverage steeping apparatus may further comprise a temperature control unit. The temperature control unit maintains the liquid at a temperature between 50° F. and 75° F. The tank may be insulated. The beverage steeping apparatus may further comprise a top cover. The mesh filter may comprise a mesh screen with spacing between 400 and 1,000 microns. The filter system may further comprise one or more filter media. The one or more filter media may comprise a first filter media, wherein the first filter media filters particulates between 25 and 500 microns. The one or more filter media may comprise a second filter media, wherein the second filter media filters particulates between 5 and 50 microns. The beverage steeping apparatus may further comprise a manual compression adjustment wheel configured to adjust filter media. The may further comprise a control panel, wherein the control panel is configured to receive input from a user, generate one or more electrical commands, and transmit the electrical commands to components of the beverage steeping apparatus. The electrical commands may control flow speed of the liquid, agitation system, duration of agitation, duration between agitation cycles, and brew time. The control panel may comprise a touch screen interface.

This invention describes a beverage manufacturing apparatus and method that is comprised of an up-right stainless steel or lined vessel. the lining of said vessel, if not stainless steel, being an FDA approved surface to allow food production. The bottom of said vessel being either a Hemispherical head, a Semi-Hemispherical head, or a Torispherical head with a extraction port centered in the bottom. Over the extraction port is a detachable inverted circular mesh type stainless steel basket filter of a cylinder, hemispherical, cone or truncated cone shape. Around the filter, a plurality of injection tubes are placed such that incoming water or fluid is injected at an angle to cause circulation. One or more upper injection tubes, envisioned to be place just below the surface of the water or fluid in a full vessel, run tangential to the. The apparatus is operated such that grounds or the particulate matter to be steeped, are deposited in the vessel with the filter in place, water or other appropriate liquid is added to a level just above the upper injectors. A circulation pump, plumbed to the extraction port draws water through the filter, and injects it back into the vessel via the plurality of injection ports. This causes the grounds to circulate around the vessel horizontally, as well as circulate from the outer edge of the vessel, along the curve of the bottom. This creates a cyclonic flow that ensures even steeping by eliminating the need for external mixers, ensures that grounds do not come to rest, and maximizes contact with all surface areas of the grounds or particulates. At the end of the steeping process, a valve in the circulation pump is opened to allow some of the finished product to escape the vessel and be collected, while continuing to pump liquid through the injectors and the product is drained. This reduces the likelihood that the filter will become blocked prematurely during drainage. An embodiment is envisioned that would inject air in some or all of the injection ports as opposed to water.

Accordingly, several objects and advantages of the invention follow. The invention enables increased safe production of steeped beverages. The invention enables a consistently high quality of beverage to be produced by providing an enclosed and controllable environment. The system increases production speed and allows optimal extraction to take less time. The apparatus is better suited for production environments and the manufacture of larger quantities per extraction and steeping cycle than current practice allows. The invention has an advantage of economy of scale—more product can be produced by fewer people with less waste, less risk, and for less money. Further objects and advantages will become apparent from a consideration of the ensuing description.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments, all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a side view of one embodiment of a beverage steeping apparatus.

FIG. 2 is a cutaway side view of the tank of a beverage steeping apparatus.

FIG. 3 is a side view of one embodiment of a portable beverage steeping apparatus.

FIGS. 4A-E are cutaway side views illustrating various container shapes and filter mesh shapes that may be used with the steeping apparatus.

FIGS. 4F-H are top plan views illustrating different inlet configurations that may be used with the steeping apparatus.

FIG. 4I is a cutaway side view of a steeping apparatus having a semi-covered top. Cutaway view showing vessel with enclosed top and preferred embodiment of head and filter combination for a water based system.

FIGS. 4J-L are cutaway side views of possible configurations of inlets for the steeping apparatus.

FIGS. 4M-N are top views illustrating alternative inlet configurations for the steeping apparatus.

FIG. 40 is a top view illustrating a possible direction of water flow for the steeping apparatus.

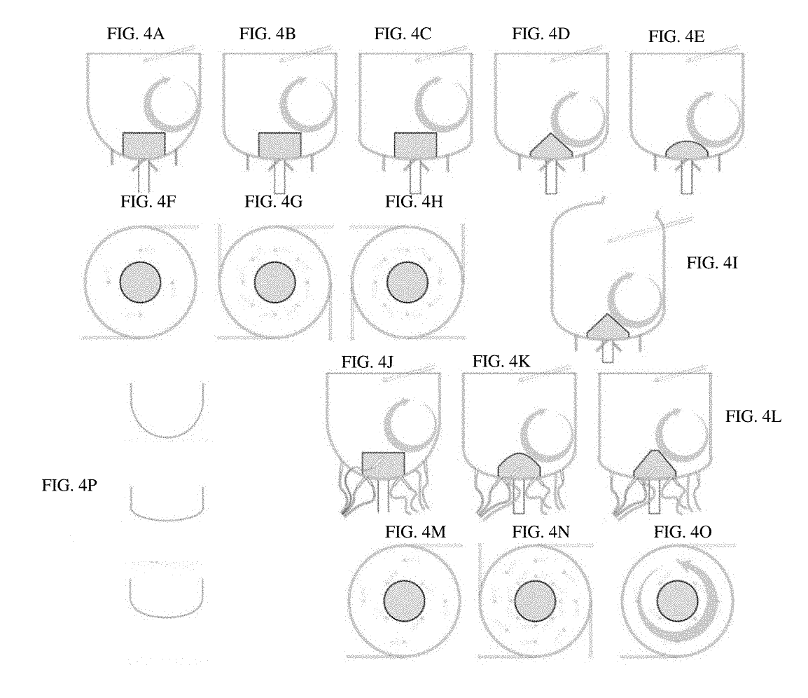

FIG. 4P are depictions of potential shapes of the steeping apparatus container.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.00110% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

In accordance with the embodiments disclosed herein, the present disclosure is directed to a beverage steeping apparatus that optimizes the steeping and brewing process for extracting compounds from particulates, such as brewing coffee grounds. In various implementations, the beverage steeping apparatus may comprise at least one agitation system for agitating liquid and particulates, wherein the resulting agitation causes the particulates to remain suspended in the liquid.

In one embodiment, there may be provided a beverage steeping apparatus that utilizes a physical agitation device, which may be controlled by a control panel or pre-programmed instructions.

In another embodiment, the beverage steeping apparatus utilizes a liquid based agitation system, wherein inlet ports inject liquid at certain angles into the beverage steeping apparatus in order to cause the liquid to move such that the particulates to remain suspended in the liquid.

In a further one embodiment, the liquid based agitation system may also include inlet ports that introduce air or other gasses under pressure into the beverage steeping apparatus, to further increase agitation.

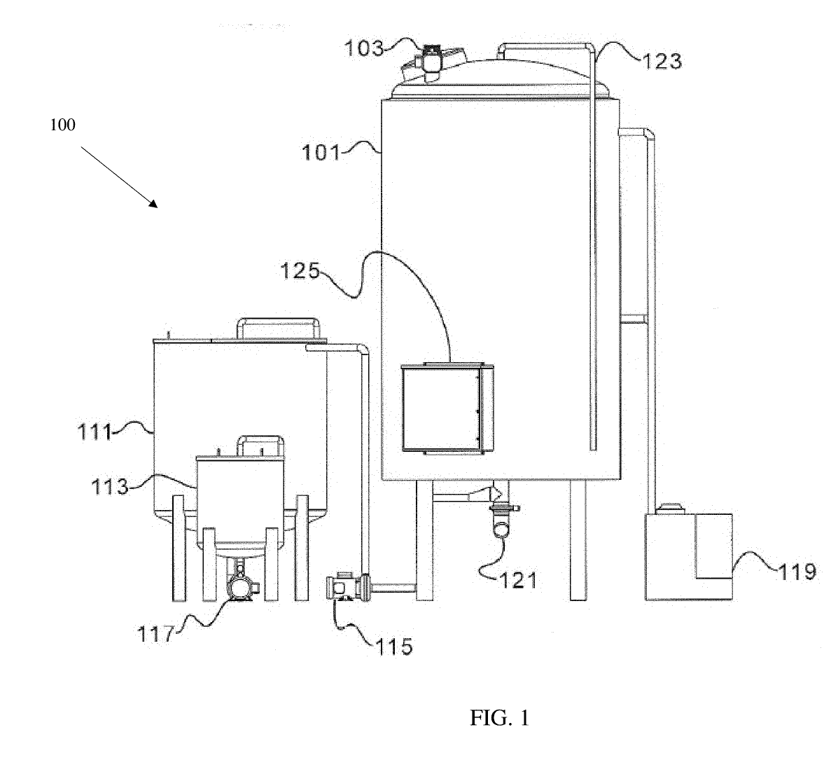

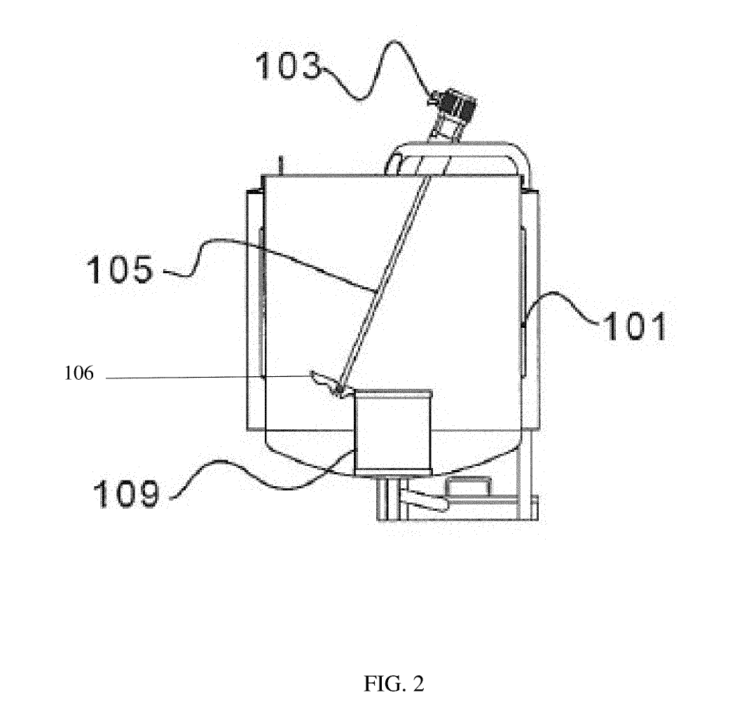

FIG. 1 is a side view of one embodiment of a beverage steeping apparatus. As shown in FIG. 1, the beverage steeping apparatus 100 may comprise a tank 101, agitation motor 103, control panel 125, waste drain 121, temperature control unit 119, filtration system pump 117, secondary filtration unit 111, tertiary filtration unit 113, circulation pump 115, clean in place system 123. The tank 101 may comprise a steel, plastic, or other food safe material. The agitation motor 103 may be a motor causing rotation of an agitation rod 105 (shown in FIG. 2). The clean in place system 123 may be a system designed to automatically clean the tank 101 and is a commercially known term. The temperature control unit 119 may be a device for controlling the temperature of the tank 101 and the tank's 101 contents. When the beverage steeping apparatus 100 comprises a temperature control unit 119, the tank 101 may also comprise a thermal insulating jacket. Alternatively, even when the beverage steeping apparatus 100 does not comprise a temperature control unit 119, the tank 101 may comprise a thermal insulating jacket. The temperature control unit 119 may heat or cool liquid directly by pumping liquid into the temperature control unit 119, or the temperature control unit 119 may directly heat or cool the tank 101.

The waste drain 121 may allow for draining of the contents of the tank 121. Alternatively, the waste drain 121 may be blocked, such as by the use of a valve, to allow liquid to be pumped out of the tank 101 by the circulation pump 115. The tank 101 may comprise a primary filtration unit 109 (shown in FIG. 2), through which the liquid may pass before being pumped out of the tank 101. In one embodiment, the liquid may be pumped into a secondary filtration unit 111. The liquid pumped out of the secondary filtration unit 111 may then be processed by the tertiary filtration unit 113 by the filtration system pump 117. After passing through the tertiary filtration unit 113, the liquid may be in a final product form and ready for consumption. Alternatively, the liquid may be in final product form once it has passed through the primary filtration unit. The secondary filtration unit 111 may filter particulates between 25 and 400 microns. The tertiary filtration unit 113 may filter particulates between 5 and 50 microns.

The control panel 125 may be a touch panel or other user interface device that may allow a user to begin, pause, continue, end, or modify an agitation cycle. An agitation cycle may be a predetermined set of electronic instructions to control the various components of the beverage steeping apparatus 100. For example, the control panel 125 may send electronic instructions to one or more of the agitation motor 103, filtration system pump 117, circulation pump 115, waste drain 121, temperature control unit 119, and clean in place system 123. The control panel 125 may comprise pre-programmed instructions, and a user may be able to modify an existing pre-programmed instruction or create a new pre-programmed instruction.

In one embodiment, water may be added to the tank, along with coffee grounds.

Before adding liquid, such as water, or substrate, such as coffee grounds, to the tank 101, the primary filtration unit 109 may be secured to the tank 101. In one embodiment, the primary filtration unit 109 may be a mesh structure. Coffee grounds may be added to the tank 101 once approximately 10 gallons of water is added to the tank 101. All of the coffee grounds intended to being added to the tank 101 may be added by the time the tank 101 is 75% full of water. Once the tank is about 25% full, the agitation process may begin, which may be controlled by the control panel. Alternatively, the control panel may begin the agitation process before or after the tank is about 25% full. Once the agitation process is completed, the liquid may be filtered through the primary filtration unit 109, and/or the secondary filtration 111 unit and/or the tertiary filtration unit 113.

Water may be introduced to the tank 101 though a pipe having an outer diameter of 1.5 inches, at a rate of between 2 and 10 gallons per minute, at a temperature between 50° F. and 75° F. In one embodiment, after the agitation cycle is completed, the liquid and substrate are allowed to rest for 30 minutes. Then, the liquid may be recirculated for no more than 30 seconds utilizing circulation valves to allow substrate to more ideally settle for filtration. The flow rate of the liquid should be relatively low during this process of recirculating to allow the substrate to settle.

FIG. 2 is a cutaway side view of the tank of a beverage steeping apparatus. As shown in FIG. 2, beverage steeping apparatus 100 may comprise a tank 101, agitation motor 103, agitation rod 105, and a primary filtration unit 109. The agitation rod 105 may comprise one or more fins 106. In one embodiment, the agitation rod 105 may be mounted between 30° and 60° as measured from the top of the beverage steeping apparatus 100. The agitation motor 103 may cause the agitation rod 105 to rotate, and the fins 106 may cause any liquid and substrate matter in the tank 101 to be agitated and/or to cause the substrate to be suspended in the liquid. The primary filtration unit may have a mesh screen having spacing of between 400 and 1,000 microns.

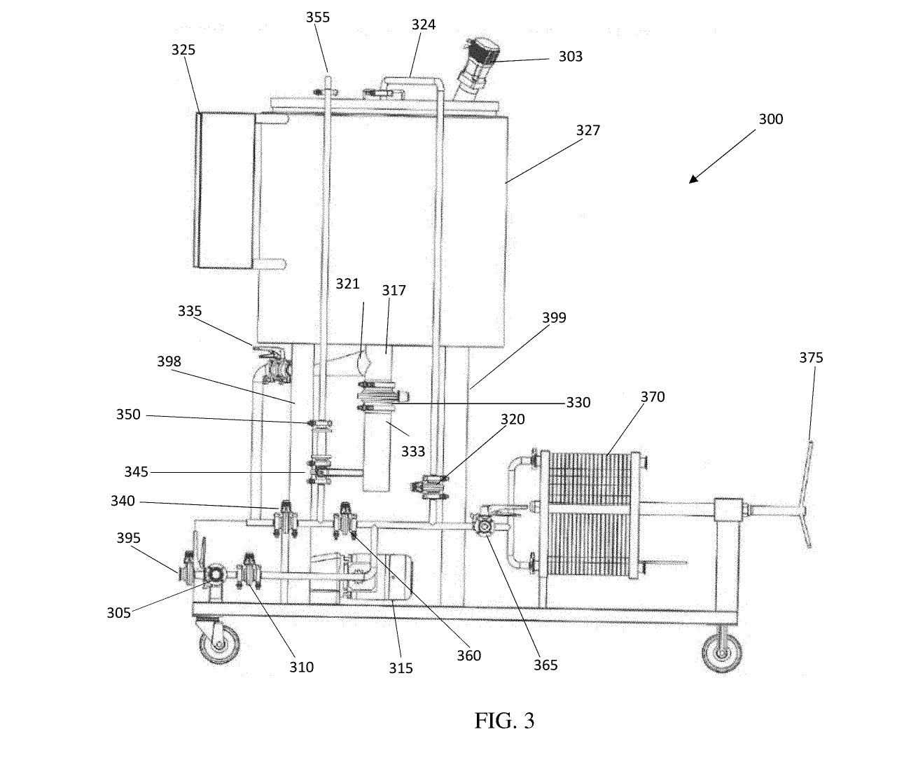

FIG. 3 is a side view of one embodiment of a portable beverage steeping apparatus. As shown in FIG. 3, the portable beverage steeping apparatus 300 may comprise an inlet 304, flow meter 305, inlet valve 310, pump 315, secondary inlet valve 320, tank water inlet 324, control panel 325, tank 327, filter outlet 321, drainage valve 330, drainage outlet 333, extraction valve 335, water recirculation valve 340, recirculation ball valve 345, sight glass 350, water recirculation inlet 355, first final filter valve 360, second final filter valve 365, final filter 370, filter lever 375. Water, or another liquid, may be introduced to the portable beverage steeping apparatus 300 through the inlet 304. After entering through the inlet 304, the rate of flow of the water may be measured by the flow meter 305 and the inlet valve 310 may control whether water is able to flow into the beverage steeping apparatus 300 and at what rate of flow. The secondary inlet valve 320 may also be configured to regulate whether water is able to flow into the tank 327.

Based on different configurations of open and closed valves, water is able to flow to different sections or portions of the beverage steeping apparatus 300 through the use of a single pump. After water passes through the secondary inlet valve 320, the water may enter the tank 327 by passing through the tank water inlet 324. The water may exit the tank 327 via the outlet 317. The water may then pass through either the filter outlet 321 or the drainage valve 330. In order to pass through the filter outlet 321, the extraction valve 335 should be open. Then, the water may pass through the water recirculation valve 340, then through the recirculation ball valve 345, wherein a user may observe the water through the sight glass 350, and then the water may pass through the water recirculation inlet 355 to re-enter the tank 327. If the water passes through the water recirculation valve 340 and the recirculation ball valve is closed 345, the water may pass through an open first final filter valve 360, through the second final filter valve 365, and into the final filter 370. The filter lever 375 may adjust the filter pressure of the final filter 370. Once water has passed through the final filter 370, it may exit through a final filtered product outlet (not shown), as is known in the art. The various valves, inlets, and outlets may be in fluid communication with one another through various pipes.

The agitation motor 303 may be substantially similar to the agitation motor 103 described in FIGS. 1-2 above. The control panel 325 may be substantially similar to the control panel 325 described in FIGS. 1-2 above. The control panel 325 may also electronically communicate with the valves in order to cause the water to flow in a specific direction.

In one embodiment, the beverage steeping apparatus 300 may comprise a temperature control unit.

Support structures 398, 399 may be used to support the tank 327 and the various components of the beverage steeping apparatus 300. Additionally, the beverage steeping apparatus 300 may be portable having a platform with wheels 397.

FIGS. 4A-P are different views and embodiments of a tank of a beverage steeping apparatus utilizing inlet port(s) to cause agitation of liquid in the steeping apparatus.

FIGS. 4A-E are cutaway side views illustrating various container shapes and filter mesh shapes that may be used with the steeping apparatus. The steeping apparatus may comprise a container, filter, inlets, an outlet, and a pump. The container may be food grade stainless steel, and have a bottom that is hemispherical, torispherical, semi-ellipsoidal, or any other shape that does not impede the circular flow of water. The filter may be cylindrical, hemispherical, cone, truncated cone, or any other shape suitable for covering the outlet with filter-like functionality. The pump may pump water out of the outlet and into the inlets. Some inlets may be used to pump in air to the container, and may be referred to herein as air inlets. In embodiments having air inlets, the overall number of inlets may be preferably increased. In a preferred embodiment, there may be lower inlets and upper inlets

The lower inlets may take water that exits the outlet, and recirculate the water into the container. The lower inlets may be angled such that when water exits the lower inlets, the water in the container is agitated, preferably in a cyclonic manner. The lower inlets may be angled upward at between about 5° and 85° as compared to the bottom of the container, and the lower inlets may also be horizontally angled substantially tangentially to a circumference having the outlet as a center. The horizontal angle may also be between −85° and 85°, as compared to tangentially to a circumference having the outlet as a center.

The upper inlets may be towards the top of the container and may be angled substantially tangentially to a circumference of circle with the outlet as a center. The upper inlets may function substantially similarly as the lower inlets.

FIGS. 4F-H are top plan views illustrating different inlet configurations that may be used with the steeping apparatus. The inlets may be configured to cause agitation in a clockwise or counter-clockwise manner. There may also be varying numbers of upper and lower inlets.

FIG. 4I is a cutaway side view of a steeping apparatus having a semi-covered top. As shown in FIG. 4I, even a single inlet port may be sufficient to enable agitation, and may be used in a semi-covered steeping apparatus.

FIGS. 4J-L are cutaway side views of possible configurations of inlets for the steeping apparatus. As shown in FIGS. 4J-L, there may be multiple lower inlets and an upper inlet. Alternatively, there may also be multiple upper inlets.

FIGS. 4M-N are top views illustrating alternative inlet configurations for the steeping apparatus. As shown in FIGS. 4M-N, there may be different numbers of inlets. In one embodiment having air inlet ports and water inlet ports, there may be additional inlet ports.

FIG. 40 is a top view illustrating a possible direction of water flow for the steeping apparatus. As shown in FIG. 40, the agitation direction may be counter-clockwise.

FIG. 4P are depictions of potential shapes of the steeping apparatus container. As shown in FIG. 4P, the steeping apparatus container may be hemispherical, torispherical, semi-ellipsoidal, or any other shape suitable for agitating liquid.

As illustrated in FIGS. 4A-P, the steeping apparatus may comprise a food grade stainless steel vessel that is manufactured from 12 gauge 304L stainless steel to meet all FDA standards, or a container. The vessel may have an opening and closure at the top also manufactured of food-grade metal components. In a preferred embodiment, the invention utilizes a semi-hemispherical bottom with an extraction port, or outlet, of varying possible size. Centered over the extraction port may be a detachable inverted circular mesh type stainless steel basket filter of a cylindrical, hemispherical, cone, or truncated cone shape, or a filter. In a preferred embodiment, the diameter of the filter may be ⅜ths the diameter of the vessel. Around the filter, a plurality of injection tubes, or lower inlets, may be placed such that incoming water or fluid is injected at an angle to enable circulation. This angle may be about 45° vertical angle in the preferred embodiment. The horizontal entry angle of the preferred embodiment may be offset from perpendicular to the radius of the vessel, such that the angle of horizontal entry is at 95° away from the center. One or more upper injection tubes, or upper inlets, may be placed just below the surface of the water or fluid in a full vessel, run tangential to the vessel with, and in a preferred embodiment have a 15° downward angle. The apparatus may be operated such that coffee grounds or the particulate matter to be steeped, may be deposited in the vessel with the filter in place, water or other appropriate liquid is added to a level just above the upper injectors. A circulation pump, plumbed to the extraction port may draw water through the filter and extraction port, and injects it back into the vessel via the injection ports. This may cause the grounds to circulate around the vessel horizontally, as well as circulate from the outer edge of the vessel, along the curve of the bottom. This may create a cyclonic flow that ensures even steeping by eliminating the need for external mixers, ensures that grounds do not come to rest, and maximizes contact with all surface areas of the grounds or particulates. The angle of injection may ensure that small particulates can continue through the system by consistently sweeping larger grounds and particulates away from the filter and ensuring that the filter does not become blocked or clogged by particulates. At the end of the steeping process, a valve in the circulation pump may be opened to allow some of the finished product to escape the vessel and be collected, while continuing to pump liquid through the injectors and the product is drained. This reduces the likelihood that the filter will become blocked prematurely during drainage.

To clean the vessel, the filter basket may be removed, and water may be pumped through the system without recirculating. The grounds may then flow out the evacuation port, and once the grounds are removed, recirculation may be turned back on, and water as well as a cleaning solution may be cycled through the system to ready it for the next batch.

An alternative embodiment may inject air in some or all of the injection ports as opposed to water. In this embodiment it may be desirous to increase the number of injection ports as air does not generally have the inertial qualities of water or liquid. It is further desirous to move injection ports closer to the filter, so that the filter is kept clear of larger particulates. The method of cleaning may differ as well. The system may be drained without recirculation, but with airflow. Once the product has been evacuated, the filter may be removed, and water and cleaning fluids may be pumped in through the upper injectors.

1. A beverage steeping apparatus comprising:
a tank; configured to store a liquid;
a filter system, wherein the filter system comprises a mesh filter;
one or more inlet ports;
an outlet port, wherein the outlet port is configured to receive and be covered by the mesh filter, wherein the mesh filter is configured to releasably engage the outlet port; and
a pump; wherein the pump is configured to pump a liquid into the tank through the one or more inlet ports and out through the outlet port; and
an agitation system configured to maintain particulate matter in a state of suspension in the liquid in the tank.

2. The beverage steeping apparatus of claim 1, wherein the agitation system comprises one or more agitators;
wherein the one or more agitators are motor-driven rotable shafts with one or more fins at a distal end of the one or more agitators, wherein the one or more agitators are mounted at an angle of between 30° and 60° from a vertical plane relative to the tank; and
wherein a rotation speed of the one or more agitators is adjustable.

3. The beverage steeping apparatus of claim 1, wherein the agitation system comprises one or more inlet ports that are configured to introduce the liquid into the vessel at a horizontal angle and vertical angle conducive to agitating particulate matter contained within the vessel.

4. The beverage steeping apparatus of claim 3, wherein the pump is configured to pump liquid through the one or more inlet ports at a rate of about 2-10 gallons per minute and into the tank.

5. The beverage steeping apparatus of claim 3, wherein the horizontal angle is between −85° and 85°.

6. The beverage steeping apparatus of claim 5, wherein the one or more inlet ports comprise at least one lower inlet port; and
wherein the vertical angle is between 5° and 85°.

7. The beverage steeping apparatus of claim 5, wherein the one or more inlet ports comprise at least one upper inlet port; and
wherein the vertical angle is between −5° and −85°.

8. The beverage steeping apparatus of claim 1, further comprising one or more recirculation valves; wherein the one or more recirculation valves comprise an open configuration and a closed configuration; wherein when the one or more recirculation valves are in an open configuration, the liquid passing through the outlet port is routed through the recirculation valves and into the one or more inlet ports; wherein when the one or more recirculation valves are in a closed configuration, the liquid that exits the tank through the outlet port and is not routed through the one or more recirculation valves to the one or more inlet ports.

9. The beverage steeping apparatus of claim 1, further comprising a temperature control unit.

10. The beverage steeping apparatus of claim 9, wherein temperature control unit maintains the liquid at a temperature between 50° F. and 75° F.

11. The beverage steeping apparatus of claim 9, wherein the tank is insulated.

12. The beverage steeping apparatus of claim 1, further comprising a top cover.

13. The beverage steeping apparatus of claim 1, wherein the mesh filter comprises a mesh screen with spacing between 400 and 1,000 microns.

14. The beverage steeping apparatus of claim 13, wherein the filter system further comprises one or more filter media.

15. The beverage steeping apparatus of claim 14, wherein the one or more filter media comprises a first filter media, wherein the first filter media filters particulates between 25 and 500 microns.

16. The beverage steeping apparatus of claim 15, wherein the one or more filter media comprises a second filter media, wherein the second filter media filters particulates between 5 and 50 microns.

17. The beverage steeping apparatus of claim 14, further comprising a manual compression adjustment wheel configured to adjust filter media.

18. The beverage steeping apparatus of claim 1, further comprising a control panel, wherein the control panel is configured to receive input from a user, generate one or more electrical commands, and transmit the electrical commands to components of the beverage steeping apparatus.

19. The beverage steeping apparatus of claim 18, wherein the electrical commands control flow speed of the liquid, agitation system, duration of agitation, duration between agitation cycles, and brew time.

20. The beverage steeping apparatus of claim 19, wherein the control panel comprises a touch screen interface.
